(19) United States
(12) Patent Application Publication
(10) Pub. No.: US 2018/0158034 A1
(43) Pub. Date: Jun. 7, 2018

(54) DYNAMIC REORDERING OF BLOCKCHAIN TRANSACTIONS TO OPTIMIZE PERFORMANCE AND SCALABILITY

(71) Applicant: International Business Machines Corporation, Armonk, NY (US)

(72) Inventors: Guerney D.H. Hunt, Yorktown, NY (US); Lawrence Koved, Pleasantville, NY (US)

(21) Appl. No.: 15/372,068

(22) Filed: Dec. 7, 2016

(51) Int. Cl. G06Q 20/02; G06F 9/46

(52) U.S. Cl. CPC G06Q 20/027; G06F 9/466

(57) ABSTRACT

A blockchain may include various transactions which are identified and which require processing. The order of processing such transactions may be optimized by examining content of the transactions. One example method of operation may comprise one or more of receiving an ordered set of proposed transactions intended for inclusion in a blockchain block, creating a lattice structure containing the proposed transactions for the blockchain block, the lattice structure comprising a top and a bottom and a plurality of nodes representing the proposed transactions, determining an order of execution of the proposed transactions for the blockchain block via the lattice structure, and processing the proposed transactions in the lattice structure in parallel based on a configuration of the lattice structure.

### TECHNICAL FIELD

This application relates to ordering upcoming transactions on a blockchain and more specifically to identifying upcoming transactions and dynamically reordering execution of any transactions that require ordering for optimizing performance of a blockchain system.

### BACKGROUND

Blockchains can be broadly divided into two classes, permissioned chains and permission-less chains, which are sometimes referred to as ‘trustless’. The leading example of a permission-less chain is the blockchain used by BITCOIN. In a permission-less chain, the committers (i.e., miners) compete to extend the chain and therefore do not agree in advance on the order of transactions within a block. Should two miners extend the chain concurrently, which is call a ‘fork’, there are methods to identify which fork to keep and discard all other forks which may have occurred. Transactions in the discarded forks, not already in the retained fork, must be reprocessed. For permissioned chains there are varying degrees of trust placed in the committers, which are the entities or nodes that update the blockchain.

Systems participating in a blockchain are typically divided into clients and committers. The clients are entities that submit transactions to committers. Committers process and “verify” these transactions, updating states or variables that are written to the blockchain. The function of the committer can be split into separate nodes. Blockchains are also distributed systems, all committers are expected to have and maintain the entire blockchain. For a permissioned blockchain, to accomplish this and assure that correctly functioning committers have identical blockchains, consensus algorithms are structured to enable the committers to independently process the transactions in the same order. A typical approach is to have one of the committing nodes in the blockchain network be designated as the “leader”. The leader organizes multiple transactions into an ordered set and communicates this ordered set to the other committers in the blockchain network. All committers then execute the transactions in the order specified by the leader. An alternative approach is to utilize a communications infrastructure that guarantees that all committers see all transactions in the same order. With this approach the committers use any method known to the art to agree on block size. For either approach, the committers communicate amongst themselves to see if they can reach consensus on the new state of the system. Once consensus has been reached, the state of the blockchain is updated with the agreed upon new state. The problem with such an approach is that existing systems require a set of transactions to be processed/verified serially and in succession one after another. The reason for this is that transaction T1 (first transaction) modifies variable V2, and transaction T2 (second transaction) reads V2 and updates variable V3, and transaction T3 reads both V2 and V3, producing V4, according to one example. If the transactions are not processed in the correct order, the committers may end up with inconsistent state data and may be unable to reach consensus on the new system state. A pure serialization scheme used to process all transactions slows down the process/verification, which increases the time required to reach consensus on the new state of the blockchain.

### SUMMARY

One example embodiment may include a method that includes at least one of receiving an ordered set of proposed transactions intended for inclusion in a blockchain block, creating a lattice structure containing the proposed transactions for the blockchain block, the lattice structure comprising a top and a bottom and a plurality of nodes representing the proposed transactions, determining an order of execution of the proposed transactions for the blockchain block via the lattice structure, and processing the proposed transactions in the lattice structure in parallel based on a configuration of the lattice structure.

Another example embodiment may include an apparatus that includes a receiver configured to receive an ordered set of proposed transactions intended for inclusion in a blockchain block, and a processor configured to create a lattice structure containing the proposed transactions for the blockchain block, the lattice structure comprising a top and a bottom and a plurality of nodes representing the proposed transactions, determine an order of execution of the proposed transactions for the blockchain block via the lattice structure, and process the proposed transactions in the lattice structure in parallel based on a configuration of the lattice structure.

Another example embodiment may include a non-transitory computer readable storage medium configured to store instructions that when executed causes a processor to perform receiving an ordered set of proposed transactions intended for inclusion in a blockchain block, creating a lattice structure containing the proposed transactions for the blockchain block, the lattice structure comprising a top and a bottom and a plurality of nodes representing the proposed transactions, determining an order of execution of the proposed transactions for the blockchain block via the lattice structure, and processing the proposed transactions in the lattice structure in parallel based on a configuration of the lattice structure.

### BRIEF DESCRIPTION OF THE DRAWINGS

FIG. 1 illustrates a logic block diagram of a blockchain transaction ordering configuration according to example embodiments.

FIG. 2A illustrates a system signaling diagram of a blockchain transaction ordering configuration when a peer is leading the consensus algorithm according to example embodiments.

FIG. 2B illustrates a system signaling diagram of a blockchain transaction ordering configuration when a consensus service receives validated transactions according to example embodiments.

FIG. 2C illustrates a system signaling diagram of a blockchain transaction ordering configuration when an endorsement service receives transactions according to example embodiments.

FIG. 3A illustrates a flow diagram of an example method of operation according to example embodiments.

FIG. 3B illustrates a flow diagram of an example method of operation according to example embodiments.

FIG. 4A illustrates an example ordered set of transactions to be committed to a block in a blockchain according to example embodiments.

FIG. 4B illustrates the state of a lattice being constructed after inserting four transactions into the lattice according to example embodiments.

FIG. 4C illustrates the state of a lattice being constructed after inserting six transactions into the lattice according to example embodiments.

FIG. 4D illustrates the state of a lattice being constructed after inserting eight transactions into the lattice according to example embodiments.

FIG. 5 illustrates a flow chart describing the scheduling of transactions contained in a lattice according to example embodiments.

FIG. 6 illustrates a flow chart describing how to construct a lattice that can be used to schedule transactions according to example embodiments.

FIG. 7 illustrates a network entity configured to support one or more of the example embodiments.

### DETAILED DESCRIPTION

It will be readily understood that the components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” may have been used in the description of embodiments, the application may be applied to many types of network data, such as, packet, frame, datagram, etc. The term “message” also includes packet, frame, datagram, and any equivalents thereof. Furthermore, while certain types of messages and signaling may be depicted in exemplary embodiments they are not limited to a certain type of message, and the application is not limited to a certain type of signaling.

In operation, when a block of transactions must be “verified”, prior to execution, the committer(s) may decide on the order of execution of the transactions in the ordered transaction set for the block. Each transaction in the set may have a “read set” and a “write set”. These two sets represent database variables in the blockchain that are to be read, updated and/or written to the blockchain and/or any associated state of the system. Logically, any variable read or write operation is dependent on any variable write operation from a prior write transaction to the same variable in the transaction set. This dependence relationship can be represented as a graph, lattice or logic diagram that can be used to generate an ideal order of parallel execution of the transactions, assuming available resources that will result in a consistent execution of the transactions across all of committer nodes for a blockchain. On average, transaction executed base on an order generated from the lattice that properly handles joins and forks can proceed in parallel rather than being serialized. In the ideal case, execution would be faster by a factor of N, where N is the number of CPUs/cores/threads available in a validating peer node. The validating peer may be a logical construct and may include more than one computer, each with one or more CPUs/cores/threads that are scheduled as a single entity.

A blockchain may store ‘state’ information. In the current distributed ledger model, there is a state in the blockchain and in the “world state”. The world state is a database of key/value pairs. CHAINCODE is an example software that may read and/or write to both the blockchain and the global state. For some implementations of blockchains, all the state is stored in the blockchain. In these environments, there is no difference between a blockchain state and world state. Each function in a CHAINCODE application can be labelled as reading and/or writing to one or more of the variables (i.e., blockchain state or world state key/value pairs). (For the purposes of this description, we treat chaincode functions and transactions as used interchangeably.) It is possible, through the use of one or more different approaches, such as annotation, static analysis, dynamic analysis and metadata analysis, to label each CHAINCODE function with read set and write set annotations. For example, CHAINCODE ‘C’ has a function ‘F’ that reads world state variable ‘wsV’ and writes blockchain variable ‘bcV’. C would be labelled with read set {wsV} and write set {bcV}. The read set and write set annotations are also updated when chaincode calls other chaincode. The dependence sets of ‘{wsV}’ and {bcV}' of the callee must be propagated to the caller's dependency sets. An alternative to propagating the read and write sets is to maintain the list of functions called by each chaincode. If this alternative is used, the function dependencies must also be propagated and taken into account during construction of the lattice. For simplicity, the propagation of the read and write sets of the callee are performed by propagating the variables into the caller's read and write sets respectively, and the propagated variables are appropriately annotated with the name of the function making the change. Each annotated variable is also annotated with the name of the chaincode that actually changes the variable. Dynamic analysis determines and records the actual read and write sets for each of the chaincode functions after the chaincode functions execute. Dynamic analysis may also include modeling how input values to chaincode functions have an effect on a set of ledger (blockchain and/or world state) variables read and/or written by the chaincode. This approach to dynamic analysis can yield a more precise description of the read and write sets for chain code functions. The set of ordered transactions to be verified (chaincode function executions) may be used to construct a lattice/graph, where ‘Top’ is the start of execution of the transactions and ‘Bottom’ is the end of all transactions. There are other embodiments using less precise constructions of the lattice than the one described herein that still properly maintain serial order of execution for parallel scheduling.

Constructing the lattice for a proposed block of transactions includes using a dependency graph that is based on the read and write sets for each of the blockchain transactions to be invoked. One such representation of a dependency graph is a lattice, although other graph representations are possible to represent the dependency relationships between the read sets and write sets. The lattice is initialized with a ‘Top’ and a ‘Bottom’ nodes. Next, the read and write sets of each transaction must be determined by any number of ways (i.e., annotations, static analysis, or dynamic analysis). Another such method is to create a data structure that points to each transaction that also contains a pointer to the read set of the transaction and a pointer to the write set of the transaction. Next, an iteration over all transactions in the transaction set is performed, including retrieving the next transaction, ‘NT’, in the transaction set. Each time a transaction is considered, it is place in a node connected to the ‘Bottom’ and the lattice is searched breadth first starting at Bottom. By iterating over the lattice in a breadth first manner starting at the ‘Bottom’, the node containing NT is placed into the lattice below all existing nodes in the lattice that have a write set containing a variable in NT write set, or write set containing a variable in NT's read set, or read set that contains a variable in NT's write set. When a node is found that NT is dependent upon, a link to NT is added in the located node and the located node is added as a predecessor to NT. If NT has no read/write set dependency on any prior transactions in the transaction set, the node containing NT can be inserted into the lattice just below the ‘Top’, and parallel to any other nodes (transactions) just below the ‘Top’. Next, if the located node, Top or an internal node, has Bottom as a successor, that link is removed (in this case NT is inserted between the located node and Bottom). Repeated iterations must be performed over the set of transactions until all transactions have been inserted into the lattice. The lattice constructed represents the maximum parallel function execution opportunity for the transaction set. Assuming an unlimited number of CPUs/cores/threads for parallel execution, the system processes the lattice, starting from the Top, and executes in parallel all transactions at each level of the lattice. Those skilled in the art will recognize that there are further performance optimizations possible when the transaction execution times or system resource consumptions are non-uniform. Once such optimization is to dynamically construct the lattice as the transactions arrive, not waiting until a full block of transactions has been received.

In operation, when there is a merge of two paths in the lattice at a node, synchronization is required, waiting for all paths prior to the merge node in the lattice path to complete execution before executing the node at the join in the lattice. Synchronization is needed because this next node in the lattice has a dependency on variables being read or written/updated farther up in the lattice closer to the ‘Top’ node. Whenever there is a fork below a node, there will be two or more links below the fork node. The transactions represented by nodes along the paths below a fork node can be executed in parallel, assuming all of the dependencies (variable read/write operations), or joins, of each node have been satisfied.

Another level of optimization may include ordering the execution of the transactions subject to the constraint(s) on the number of available processors (e.g., CPUs, cores, threads). As an alternative, to maximize throughput, execution time of each of the transaction can be considered. An estimate of execution time can be derived from execution traces and/or metadata, such as annotations, that specifies the maximum amount of time that the function or transaction is expected, or allowed, to execute. The available resources can be determined using techniques from a compiler technology related to multi-core and/or MIMD systems. Validation of transactions can be parallelized on the same, or collaborating application systems, and transactions can be reordered without affecting consensus, for properly behaving (i.e., non-faulty) validating peers, by observing dependency relationships between transactions (e.g., the read and write sets). For example, independent transactions can be executed in parallel. The computing resources (e.g., processing cores) and dependent transactions are serialized to maintain an effective order prior to execution. The committer(s) can decide on the order of commitment of the transactions in the ordered transaction set for the block. Other operations include creating a dependence graph to show the relationship between read and write sets for transactions, where a variable read is dependent on any variable write operations from a prior transaction's write to the same variable in the transaction set representing this dependence relationship. A lattice represents an ideal order of parallel execution of the transactions.

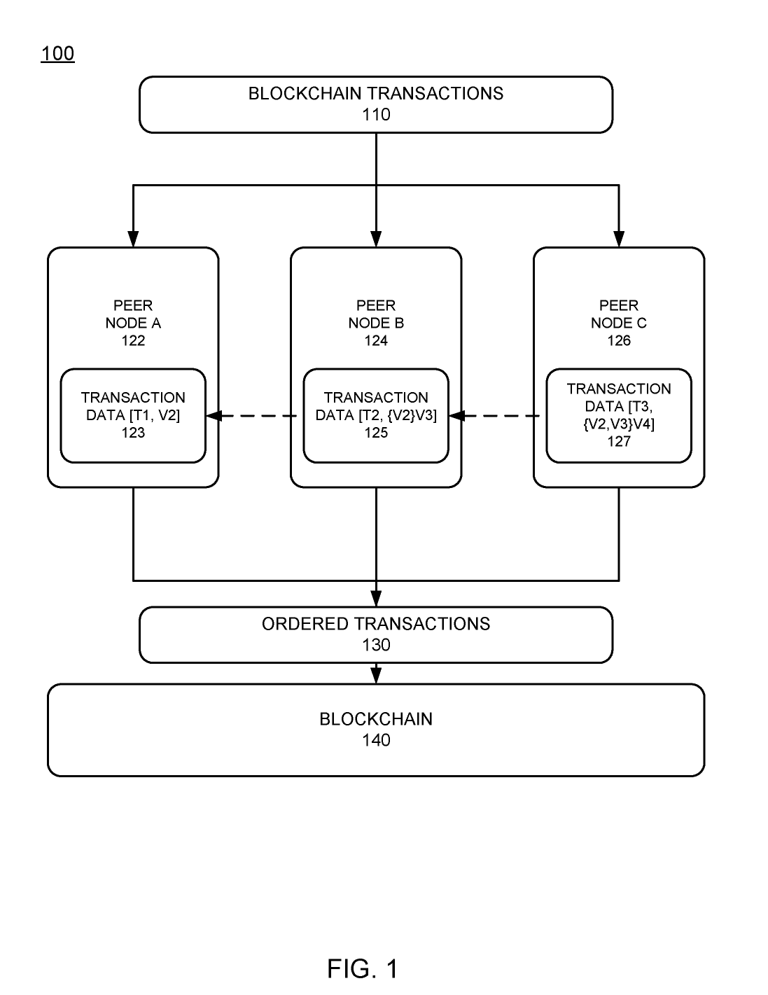

FIG. 1 illustrates a logic block diagram of a blockchain transaction ordering configuration according to example embodiments. Referring to FIG. 1, the example diagram 100 includes various blockchain transactions 110 being received by peer network nodes which are attempting to process the transactions. The peer nodes 122, 124 and 126 may represent any entities which operate with the network and which process, receive and/or contribute to the blockchain transactions. In this example, the three are currently receiving and attempting to process/validate and/or order/reorder transactions 123, 125 and/or 127. In this figure, the transactions 125 and 127 are dependent transactions which reference variables from at least one of the other transactions. For example, T2 may require variable V3 which is based on V2, and the variable V4 in T3 is based on V2 and V3 from prior transactions. Before the transactions can be processed, the order of the transactions must be decided. The peer nodes 122, 125, 126 pass the transactions they have received to ordered transactions 130 and the other peers. Alternatively, any infrastructure could be used that guarantees all peers will receive all transactions. When ordered transactions receives enough transactions to constitute a block, it communicates the order of those transactions to the peer nodes. The transactions are then processed/validated by the peer nodes 122, 124, 126 prior to being stored in the blockchain 140.

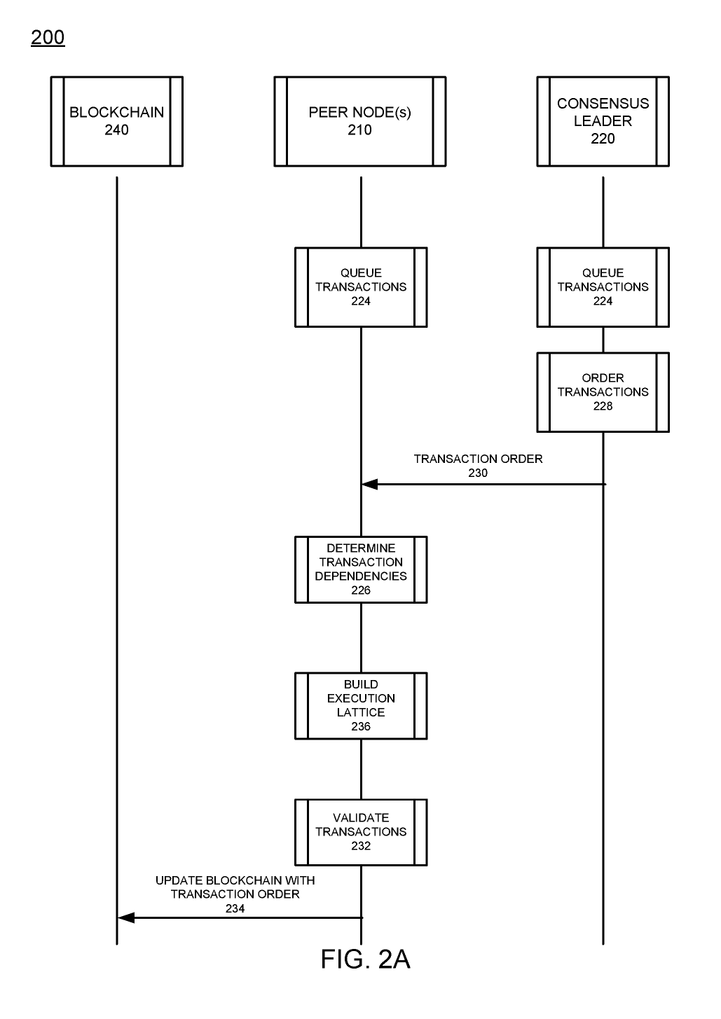

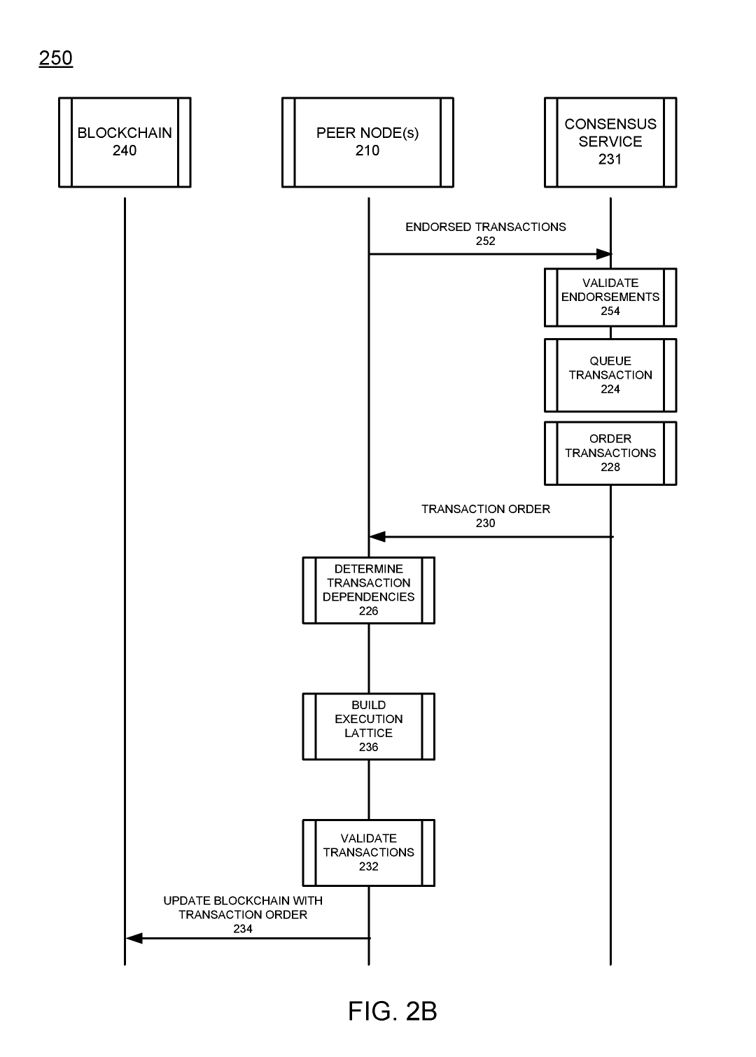

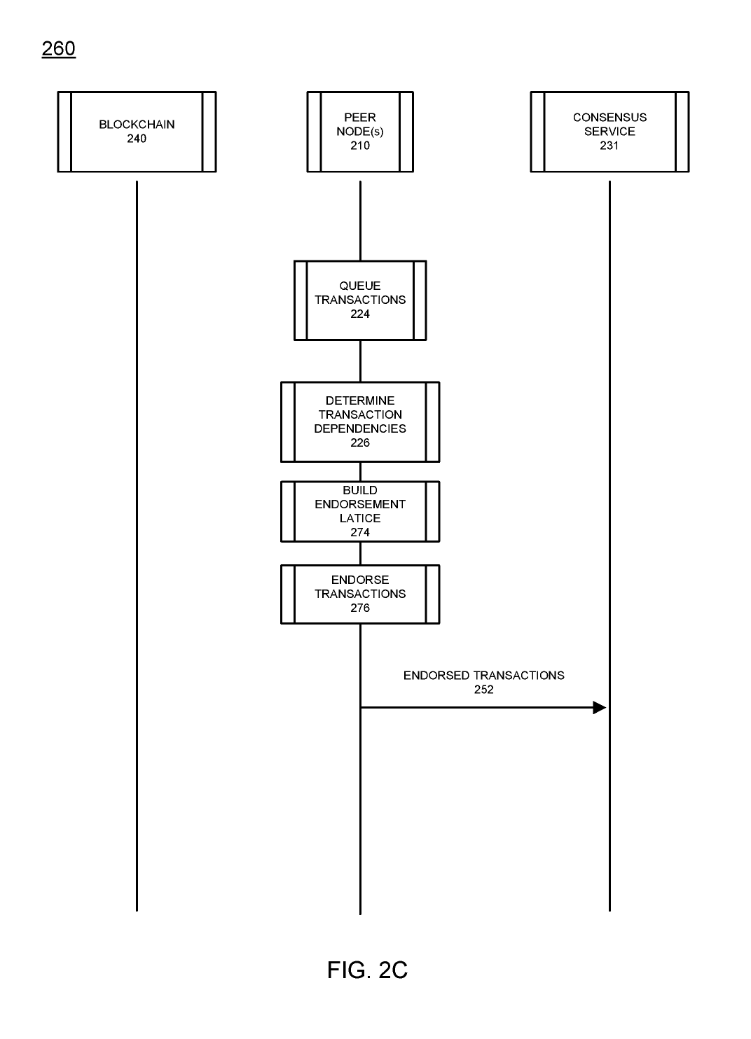

FIG. 2A illustrates a system signaling diagram of a blockchain transaction ordering configuration according to example embodiments. Referring to FIG. 2A, the peer nodes 210 represent any nodes which receive transactions. The consensus leader 220 is the peer node that will lead the consensus protocol by determining the order of transactions. All peer nodes, including the consensus leader, receive all transactions. The peer nodes may pre-process transactions, for example, by receiving and confirming the transactions, however, the consensus leader must determine the order to process the transactions prior to the results being stored in the blockchain 240. The transactions are received by all peers 210 and queued 224. Through any mechanism known to the art, a decision is made by the consensus leader 220 or among the peers 210 that a sufficient number of transactions have been received for a block. The consensus leader 220 orders the transactions 228 and distributes the transaction order to the peers 230. The transaction content is then analyzed to determine the dependencies 226. The dependency determination can include any feature known to the art of the infrastructure or of the transactions that could be used to determine ordering of execution. In the simple case the dependency analyzer 226 uses read and write dependencies base on the distributed order 230. The lattice described in this application is then constructed 236. The lattice will be used to direct the processing (or validation) of transactions in a parallel and/or series 232. After the processing has occurred, the blockchain 240 may be updated with the transaction data 234 by storing the transactions in blocks. Those skilled in blockchain understand that blockchain 240 represents the blockchain maintained by each peer node 210, and that a consensus leader 220 may be part of one of the peer nodes 210. This figure represents one possible protocol, however, others are possible. Those skilled in the art will also recognize that parallelization of storage of the updated transaction data (variables) can be performed using a lattice scheduling algorithm, and will also recognize that that the lattice construction algorithm herein can be used if only the write set is considered during the lattice construction (ignoring the read sets). Using the resulting lattice allows maximum throughput of updating the blockchain/world state.

FIG. 2B, illustrates a different signaling diagram of a blockchain transaction-ordering configuration according to example embodiments. Referring to FIG. 2B the consensus service 231 is separate from the peers and only receives endorsed transactions 252. The peer nodes 210 represent any nodes which receive transactions. All peer nodes eventually receive all transactions. The peer may pre-process transactions, and reach agreement with other peers that the transactions are valid. The process of reaching agreement may cause a transaction that was received by only one peer to be broadcast to all the peers. This agreement is call endorsement. However, the consensus service must determine the order to process the transactions prior to the transaction results being stored in the blockchain. The endorsed transactions are received 252 by the consensus service 231. The consensus service validates the endorsements 254 and queues the valid transactions 224. Through any mechanism known to the art, a decision is made by the consensus leader (or among the peers) that a sufficient number of transactions have been received for a block. The consensus leader orders the transactions 228 and distributes the transaction order 230 to the peers 210. The transaction content is analyzed to determine the dependencies 226. The dependency determination can include any feature known to the art of the infrastructure or of the transactions that could be used to determine ordering of execution. In the simple case the dependency analyzer uses read sets and write sets dependencies based on the distributed order 230. The lattice is then constructed 236. The lattice will be used to direct the processing (or validation) of transactions 232 in a parallel and/or series. After the processing has occurred, the blockchain 240 may be updated with the transaction data 234 by storing the transactions in the block. Those skilled in blockchain understand that blockchain 240 represents the blockchain maintained by each peer node 230. This figure represents one possible protocol. Others are possible such as dividing the function listed here as a peer node into separate nodes or dividing the function here listed as consensus service into separate nodes.

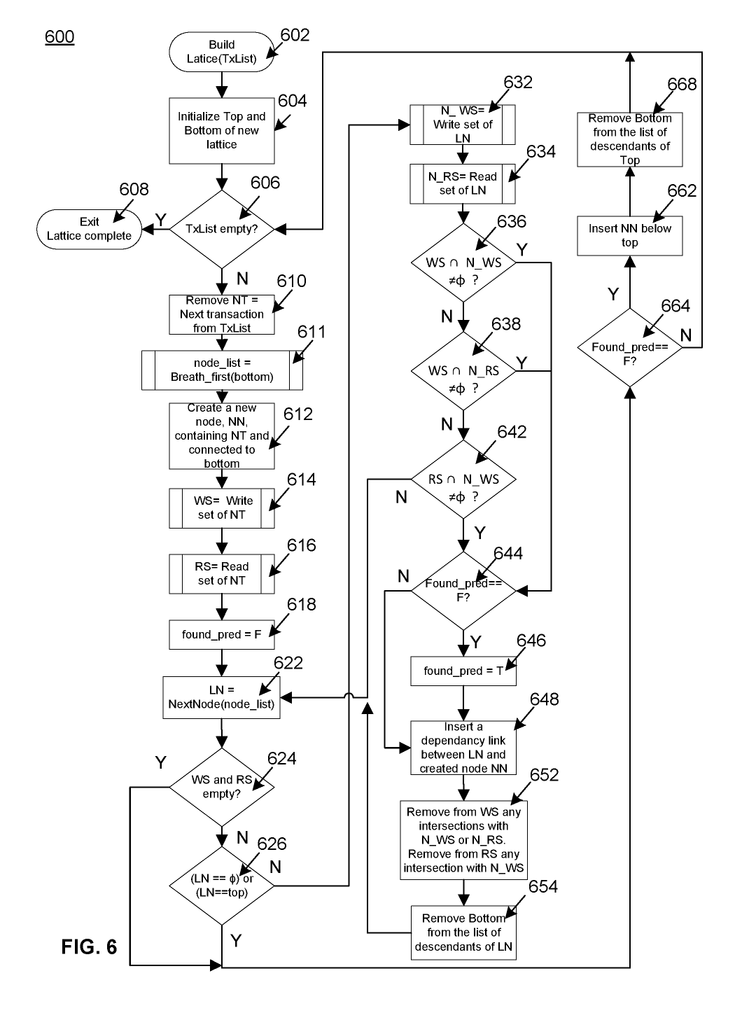

Referring to FIG. 2C, this system configuration illustrates another signaling diagram of a blockchain transaction-ordering configuration according to example embodiments. In FIG. 2C, the consensus service 231 is separate and only receives endorsed transactions 252. The peer nodes 210 represent any nodes which receive transactions. All peer nodes eventually receive all transactions. The peer nodes need to endorse all transactions prior to sending them to the consensus service. The peers desire to maximally parallelize the endorsement process. Transactions can be queued 224. The transactions are analyzed to determine the dependencies 226. The dependency determination can use annotation, static analysis, or dynamic analysis as previously described. In the simple case, the dependency analyzer uses read and write set dependencies. Note that it is also possible to incrementally determine the dependencies between transactions 226 without waiting for all transactions to be queued 224. The endorsement lattice is then constructed 274 using the algorithm of FIG. 6. The lattice will be used to direct the processing (or endorsement) of transactions 276 in a parallel and/or series. The endorsed transactions are sent 252 to the consensus service 231. The remaining processing is described FIG. 2B.

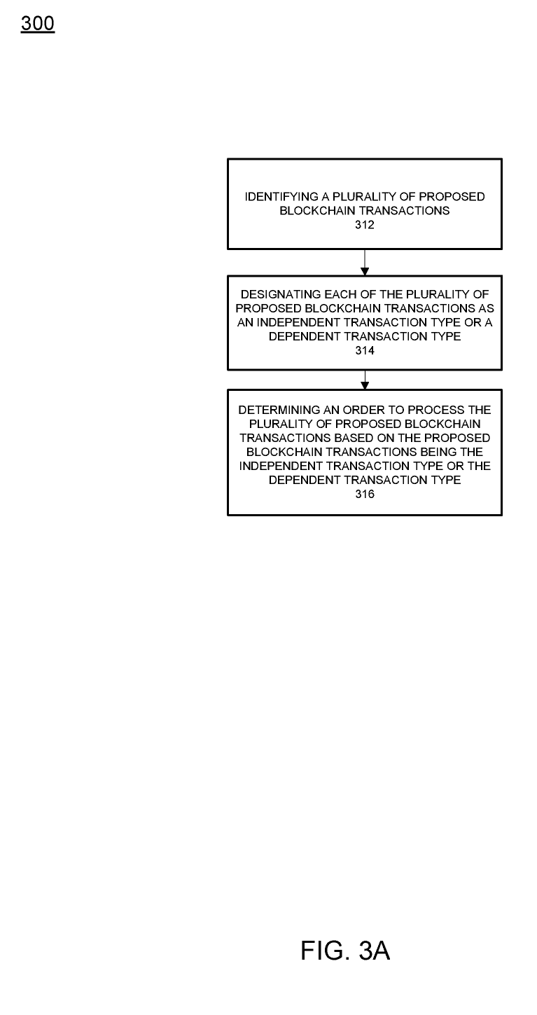

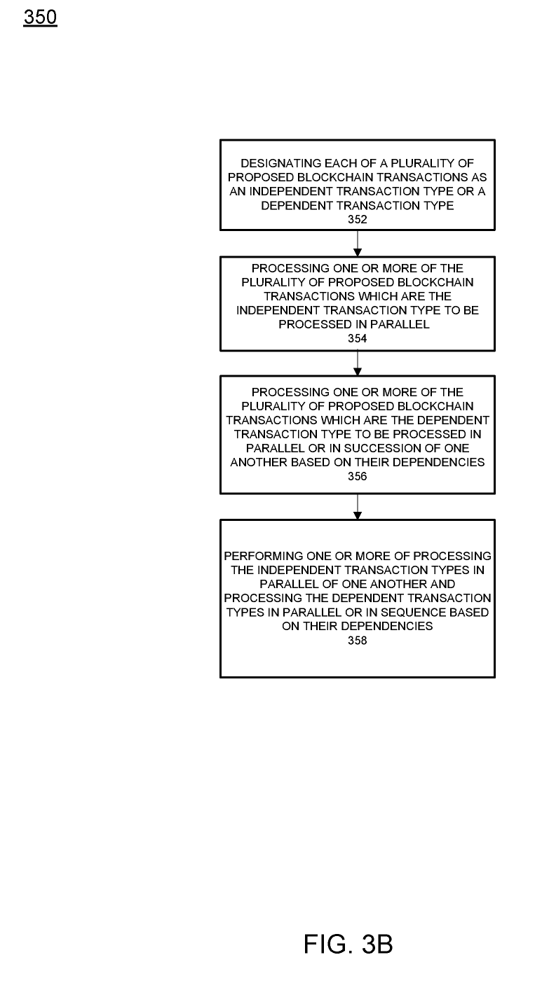

FIG. 3A illustrates a flow diagram of an example method of operation according to example embodiments. Referring to FIG. 3A, the method 300 may include identifying a plurality of proposed blockchain transactions 312, designating each of the plurality of proposed blockchain transactions as an independent transaction type or a dependent transaction type 314, and determining an order to process the plurality of proposed blockchain transactions based on the independent transaction type or the dependent transaction type 316. The independent transaction types are identified based on no matching read sets or write sets which correspond to any of the other proposed blockchain transactions. The dependent transaction types are identified based on intersecting read sets or write sets with any of the other proposed blockchain transactions. The method may also include ordering one or more of the plurality of proposed blockchain transactions which are the independent transaction type to be processed in parallel and/or ordering one or more of the plurality of blockchain transactions which are the dependent transaction type to be processed in parallel based on their dependency structure. The method may also include creating dependency information to include a relationship between one or more of the read sets and the write sets for one or more of the proposed blockchain transactions. The one or more read sets of a first proposed blockchain transaction are dependent on the one or more write sets from a prior proposed blockchain transaction conducted prior to the first proposed blockchain transaction.

FIG. 3B illustrates a flow diagram of an example method of operation according to example embodiments. Referring to FIG. 3B, the method 350 may include designating each of a plurality of proposed blockchain transactions as an independent transaction type or a dependent transaction type 352, processing one or more of the plurality of proposed blockchain transactions which are the independent transaction type to be processed in parallel 354, processing one or more of the plurality of proposed blockchain transactions which are the dependent transaction type to be processed in parallel or in succession of one another based on their dependencies 356. Performing one or more of processing the independent transaction types to be processed in parallel of one another and processing the dependent transaction types to be processed in parallel or in sequence base on their dependencies 358. In this example, security or other reasons may dictate the processing of dependent transactions in parallel and independent transactions in series to negate concerns about expected processing procedures. It may also be efficient to process the transactions in such a manner to optimize resources depending on the available resources and the types of transactions received. For instance, if all transactions that are eligible to be processed in parallel are processed in parallel for a predetermined amount of time, this may permit an opportunity to identify whether additional transactions can be processed depending on a number of transaction variables which have been completed.

Example embodiments provide validating peers in a shared ledger permissioned blockchain configuration. By shared ledger we mean the complete ledger is located and maintained by each validating peer. Other approaches to maintain the ledger are possible, such as splitting the ledger state between validating peers. These approaches are documented in the distributed systems research publications. It does not matter whether a validating peer and a consenter are a single node or separate nodes. In the case were they are separate nodes, the node containing the validating peer will be used. In order to function, it is required that there is agreement between the validating peers or components performing validation on the order of the transactions to be executed. PBFT is an example of a consensus algorithm where the transactions are ordered before being processed. Ordering of transactions is a common feature of distributed consensus algorithms to help minimize thrashing. Chaincode is another type of program, Chaincode can contain a “function” or subroutines which are executable by other Chaincode. When having an ordered list of transactions, the maximum degree of parallelism that can be achieved may be desired for optimal performance of transaction processing.

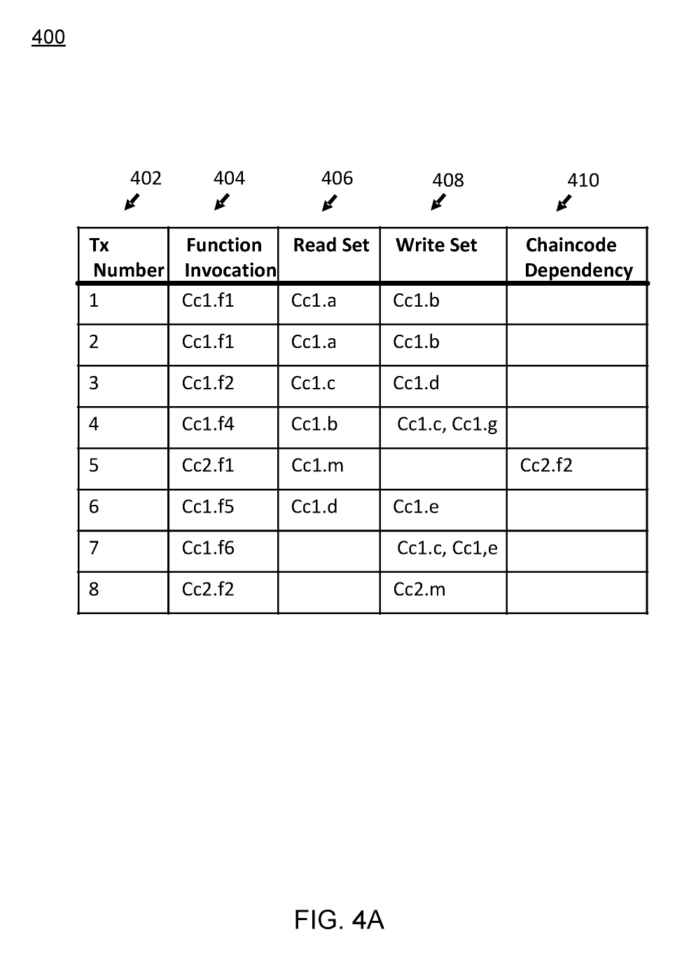

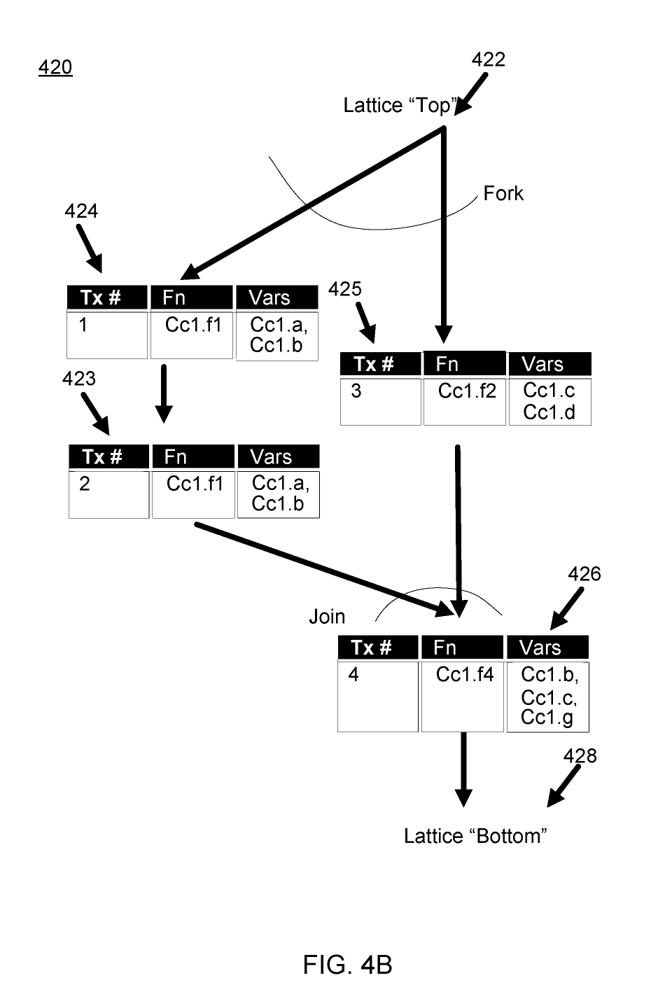

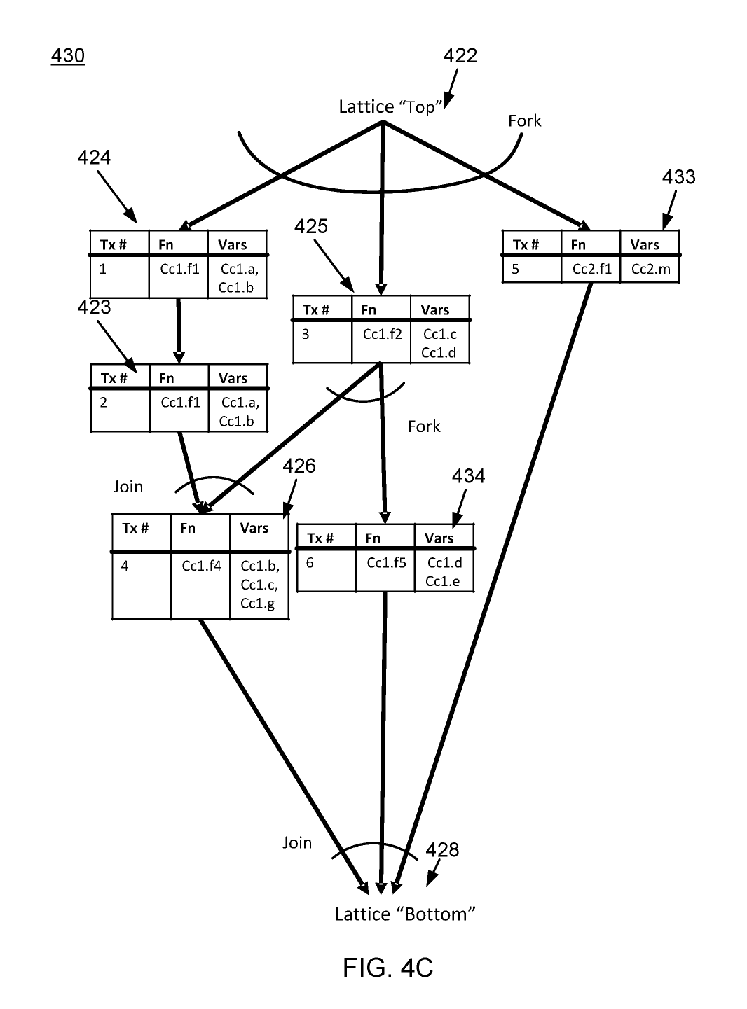

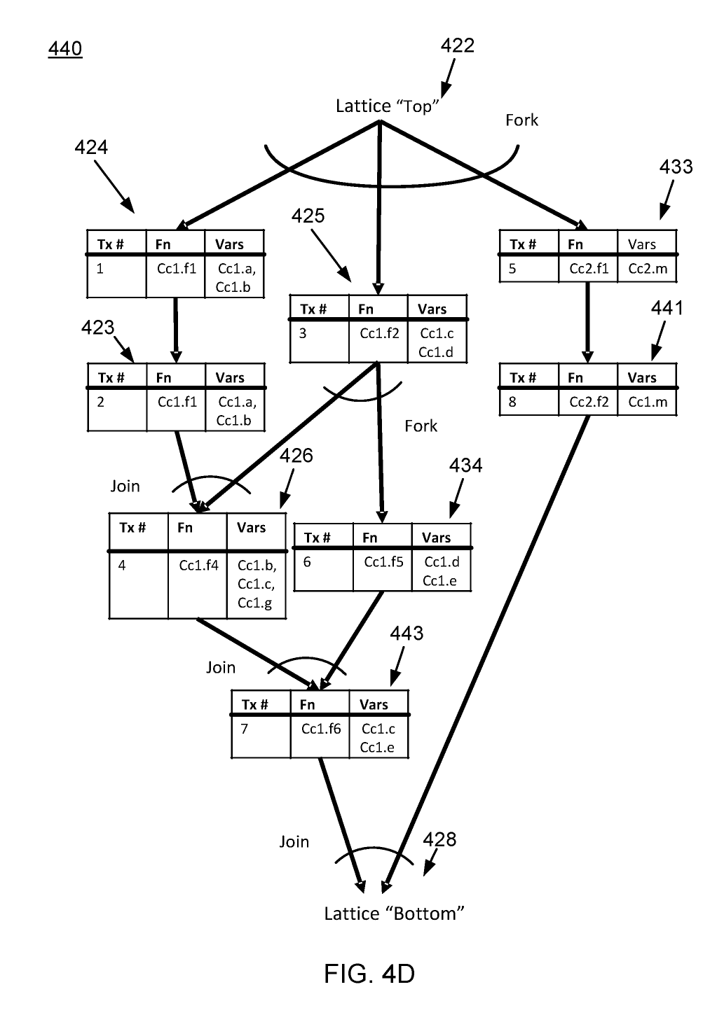

FIG. 4A illustrates an ordered list of blockchain transactions according to example embodiments. Referring to FIG. 4A, the table 400 includes an ordered set (list) of eight (8) hypothetical transactions such that each line is one proposed blockchain transaction. In this figure, the expression “xxx.yyy”, xxx always represents a chaincode identifier and “yyy” can represent either a function name or a variable name. For simplicity in this example all function names start with ‘f’ since they are all qualified by chaincode ‘ID’, and function names are not globally unique. The columns of the table are defined as follows: the transaction number 402 represents the nominal order in which the proposed transactions will be executed. The function invocation 404 is the chaincode and function used by the proposed transactions. The read set 406 is the set of variables that are read by the proposed transactions. The write set 408 is the set of variables that are written by the proposed transactions. The chaincode dependency 410 represents chain code functions or variables that the chaincode is dependent on. Since the set of proposed transactions has already been ordered, the parallelism must maintain the effects of this order. For example, if multiple transactions write to the same variable, these transactions must execute in the same order as in the nominal order that the transactions were originally ordered, etc. to achieve the desired state.

When constructing a lattice of nodes having one or more transactions, given an ordered set of transactions to be verified, an empty lattice is initialized. This includes designating the ‘Top’ node, representing the start of execution of the transactions, and a ‘Bottom’ node representing the end of all transaction executions. Next, the read and write sets of each transaction must be determined by any number of means (including through annotations, static analysis or dynamic analysis). An iteration over all transactions in the transaction set is performed, including retrieving the next transaction, ‘NT’, in the transaction set. Each time a transaction is considered, it is place in a (new) node connected to Bottom. For each transaction considered, by iterating over the lattice in a breadth first manner starting at bottom, the node containing NT is placed into the lattice below all existing nodes in the lattice that have a write set containing a variable in NT's read set or write set or that read a variable in NT write set. If NT has no read/write set dependency on any prior transactions in the transaction set, the node containing NT can be inserted into the lattice just below ‘Top’, and parallel to any other nodes (transactions) just below Top. Repeated iterations must be performed over the set of transactions until all transactions have been inserted into the lattice. The lattice constructed represents the maximum parallel function execution opportunity for the transaction set. Assuming an unlimited number of CPUs/cores/threads for parallel execution, the system application processed the lattice, starting from the Top, and execute in parallel all transactions at each level of the lattice. Those versed in the art will recognize that there are further performance optimizations possible when the transaction execution times are non-uniform.

For clarity, in this description, each node in the lattice contains one transaction. Those skilled in the art understand that each node in the lattice could contain an ordered list of one or more proposed transactions. Such a lattice could be derived from the lattice constructed herein or constructed directly without first creating a lattice were each node contains one transaction. The dependence graph is based on the relationship between the read and write sets for each of the blockchain functions to be invoked by the transactions and the given order of the transactions iterate over all of the transactions in the transaction set in the given order. Next, the next transaction (NT) is received from the ordered list of transactions.

FIG. 4B illustrates a lattice structure 420 where the Top of the lattice 422 is defined along with the Bottom of the lattice 428. The first node 424 has one proposed transaction. The second node 423 has one proposed transaction, the third node 425 has one proposed transaction and the fourth node 426 has one proposed transaction. When constructing the lattice, the nodes must be searched in breadth first order starting at ‘Bottom’. The lattice construction algorithm iterates over all transaction in the list. Each time a new transaction, NT, is processed, the node that represents it is automatically connected to the Bottom. The NT is placed into the lattice below all existing nodes in the lattice that have a write set containing a variable in NT's read set or write set in NT's write set or that read a variable in NT's write set. Note that any proposed transaction that has no read or write set dependency on any prior proposed transactions in the transaction set can be inserted into the lattice just below Top, parallel to any other nodes (proposed transactions). This process is iterated until all proposed transactions for a block have been inserted into the lattice. There may be many iterations performed when constructing the lattice. A proposed transaction may be included as part of an existing node in the lattice when the proposed transaction to be added to the lattice would only have a single predecessor node in the lattice. The lattice in FIG. 4B represents the state of construction after four transactions from the list in FIG. 4A have been processed.

In the final lattice, “forks” represent opportunities for parallel execution. For example, in FIG. 4B, it is clear that transaction three (3) 425 can be executed in parallel with transaction one (1) 424. In the lattice of FIG. 4B, the ‘join’ represents synchronization points. All blocks of transactions above the join must be completed before any transaction after the join. Before processing transaction four (4) 426, synchronization is required since transactions one (1) 424, two (2) 423 and three (3) 425 must have completed first. Each validating peer can independently construct the lattice based on the ordered set of transactions received as part of the PBFT consensus algorithm or any other algorithm that orders the transactions prior to consensus. A validating peer is a single node in the ledger system. This node can be a single processor with multiple threads or a collection of processors acting as a single node in the overall blockchain network.

Referring to FIG. 4C, execution of lattice forks can proceed in parallel. Execution of lattice joins are synchronization points. For example, if the dependency graph illustrated in the previous fork was scheduled on a four thread system, t1, t2, t3, and t4, the block starting with proposed transaction one could be scheduled on t1. The block starting with proposed transaction 3 could be concurrently scheduled on t2. The block starting with proposed transaction 5 could be concurrently scheduled on t3 as illustrated in FIG. 4C. The example 430 represents the state of the lattice after six proposed transactions have been inserted into the lattice. There is one proposed transaction for each of the nodes 424, 425, 423, 426, 433 and 434. The join is where the nodes meet, which requires all previous proposed transactions to be completed. The Top of the lattice 422 is the starting point for all paths through the lattice and the Bottom 428 is where all paths through the lattice end.

One way to accomplish the processing is to schedule a block of proposed transactions on a thread and have them return to the scheduler when they complete. At this point the scheduler would identify what else could be scheduled at any given time. When all threads have completed and there is nothing left to schedule, the validating node has finished validating the proposed transactions and can continue with the consensus algorithm. This technique works whether the validator has multiple cores with multiple threads or consists of multiple machines. The synchronization and signaling techniques differ depending on the architecture of the validator and are well understood in the art.

FIG. 4D illustrates a further example 440 the state of the lattice after inserting the 8 proposed transactions from FIG. 4A into the lattice according to example embodiments. In this example, node one 424 has one proposed transaction. The second node 423 also has one proposed transaction and the third node 425 also has one proposed transaction. The joins illustrate the completion point of several transactions. In this example, 441 and 443 are also included as proposed transactions 8 and 7.

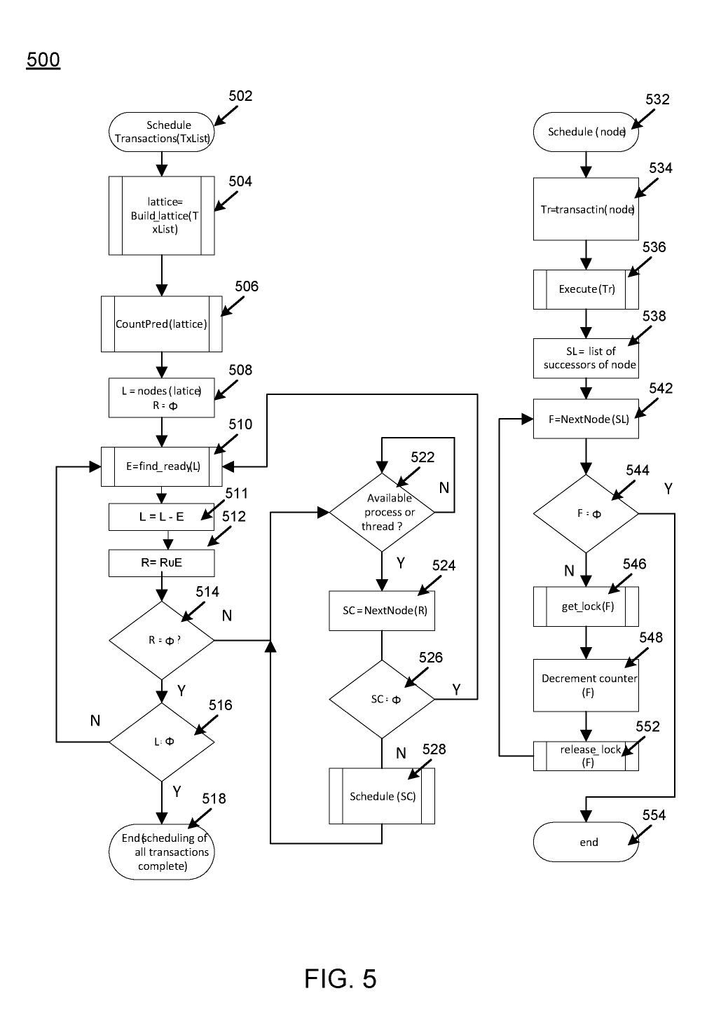

Before discussing the flow chart illustrated in FIG. 5 the functions and variables that are used are described in detail. The proposed transaction scheduling algorithm is also referred to as Schedule Transaction. In one example, a multi-threaded single or multiple core machine may be used to perform the scheduling. In a more complex form, this could be a distributed set of computers. For all such cases, there is a mechanism to determine which units are available for proposed transaction (code) execution. The Bottom is the last node in the lattice. All paths in the lattice, starting from the Top, terminate at the Bottom. Bottom does not have any successor nodes. Bottom is often represented by an upside down capital t (⊥). Build_lattice is a function that builds the lattice that drives scheduling. Its function is sufficiently complex that the description of the algorithm is represented in FIG. 6. CountPred is a function that goes through each node in a lattice and sets the count field to the number of non-Top predecessors nodes for each node in the lattice. If the only predecessor of a node is Top, the count is set to zero. Any method that successfully traverses the lattice without duplication (counting the same predecessors multiple times) is acceptable. This description uses a lattice node that contains a count. Any method of associating a predecessor count with the lattice node will be acceptable. This count represents the number of nodes (proposed transactions assuming one transaction per node) that must executed prior to the current node's proposed transaction(s) execution. The algorithm described below will decrement this count whenever a predecessor node (proposed transaction) completes execution.

‘E’ is a list of nodes (proposed transactions) that are ready for execution; this list is constructed by the function find_ready. ‘F’ is a reference to a node in the lattice. ‘get_lock’ gets the lock for that node. The lock is a semaphore that only permits one process to decrement the predecessor count for the node. Manipulating semaphores for all system architectures is well understood in the art. ‘find_ready’ is a function which goes through a list of nodes in the lattice that still need to be scheduled and returns the list of nodes where the predecessor node count is zero and has not already executed the proposed transaction(s) represented by the node.

A zero count indicates that all predecessor nodes (proposed transactions) have completed execution so that the node can be scheduled for execution. ‘L’ is a set that represents all of the nodes (proposed transactions) in the lattice, exclusive of the ‘Top’ and ‘Bottom’. ‘Lattice’ is a directed graph without cycles with a single start node, ‘Top’, and a single end node ‘Bottom’. ‘NextNode(X)’ is a function over the ready transaction in ‘R’ that removes a node from the list of nodes, X, and returns the node. A ‘Node’ represents each node of the lattice which contains, or references, a transaction request, a lock, a count of the number of predecessor nodes (exclusive of the Top), and a list (or set) of its predecessor and successor nodes in the lattice. The ‘release_lock’ releases the lock associated with a particular node. ‘R’ is a set that represents all of the nodes (proposed transactions) that are ready for execution. These nodes do not have any predecessor nodes in the lattice that still need to execute. Specifically, each node in R has a count of zero. ‘Schedule’ is a function, which takes a node and executes the transaction that is associated with that node. The call to schedule is asynchronous, returning to the caller as soon as the system has created a thread or process to execute the scheduling routine. The maximum number of concurrent transactions that are executing is dependent on the architecture of the system and available resources where the transactions are being executed. A flowchart of the scheduling routine is included. This concept is well known in the art. SL is a copy of the list of successors of a node. If the only successor is the Bottom, then it is empty. The Top is the first node in the lattice (a directed graph) which has no predecessors. All paths through the lattice start with the Top and terminate with the Bottom. The Top is represented by the symbol T (capital t). The ‘transaction’ is a routine that returns the transaction associated with a node. ‘Φ’ represents the empty set. ‘∪’ is used to represent set union. Each node in the lattice represents or contains a transaction to be executed. In simpler processing models, this may be transaction execution. In other execution models, this may be transaction speculative execution. Each node also contains a list of predecessor nodes in the lattice and a list of successor nodes in the lattice.

FIG. 5 illustrates a flow diagram corresponding to the transaction scheduling algorithm. Referring to FIG. 5, the main algorithm includes scheduling a transaction list 502 by initializing, repeating and continuing until ‘L’ is empty. The lattice is built based on the transaction list 504. The count of predecessor nodes 506 may be performed, not including the Top node. The set ‘L’ may be initialized to include all of the nodes in the lattice, exclusive of the ‘Top’ and ‘Bottom’ nodes. Next, a set R is initialized to empty 508. Next, nodes are identified which are ready for execution (find_ready( ) and are put in list E 510. Then nodes that are ready to be scheduled, those in the list E, are removed from the set of lattice nodes 511, L, that will be searched for ready nodes and the nodes that are ready are added to ‘R’ 512, if R is non-empty 514, the algorithm prepares to schedule the nodes that are ready. First it checks to see if there are resources available so that transactions can be schedule 522. Once resources are available, it selects the next ready node 524. If there are no more nodes available to be scheduled 526, it returns to look for more nodes that are ready to be scheduled in 510. Otherwise it schedules the transaction in node SC, 528 and returns to check that there are available resources to schedule the next node 522. Returning to 514, if there are no nodes ready to be scheduled, the algorithm checks to see if all nodes in the lattice have been processed 516. If they have not been processed it continues to look for nodes ready to be scheduled in 510. Otherwise scheduling of node is complete 518.

Schedule(node) function 532 proceeds by obtaining the transaction from the node 534 and executing the transaction 536. Once the transaction has completed execution, the predecessor count on all successor nodes must be decremented. Next, a list of successor nodes ‘SL’ is obtained 538. The next successor, F, is removed from the list 542. If the successor is empty 544 there are no remaining successors that need their predecessor count decremented so the scheduler exits 554. Otherwise, it obtains the lock for the successor node 546, decrements the counter 548, and then releases the lock 552. Once the lock has been released it returns to obtain the next successor from the list of successors 542.

Before discussing the build lattice algorithm as represented in FIG. 6 the functions and variables used to define its operation are described in detail. For the lattice building algorithm, the ‘Bottom’ is the last node in the lattice (graph). All paths in the lattice, start from ‘Top’ and terminate at Bottom. The Bottom does not have any successor nodes. The Bottom is often represented by an upside down capital t (⊥). The bottom of lattice is where scheduling converges or ends. Breadth first search: is a standard term from graph theory, an algorithm that is understood by persons skilled in the art. ‘Breadth_first’ is a routine that takes a lattice node as input and returns an ordered list (set) of nodes generated in breadth first order with duplicates removed. False or ‘F’ represent false in Boolean logic, ‘Fork’ refers to a node in the lattice where two or more descendants are dependent upon the predecessor. ‘found_predecessor’ or (found_pred) is a variable use to track whether the current node (transaction) being inserted into the lattice was already inserted in at least one location in the lattice. If the lattice was searched and the current node does not have any predecessors, then the node should be inserted below the Top. The current node is independent of all transactions currently in the lattice. ‘NextNode’ is a routine that takes an ordered list of lattice nodes, removes the first node from the list and returns it. ‘Join’ refers to a node in the lattice that has dependencies on two or more predecessor nodes. ‘LN’ is the variable that represents the next node in the lattice to be processed in the breadth first search of the lattice. ‘NN’ is a new node that will be inserted into the lattice. New nodes are always created with a successor of the Bottom node. ‘NT’ is a next transaction. Get next transaction means assign the node (transaction) to NT and remove it from the transaction list. Ordered transaction list refers to the list of proposed transactions for a proposed block of the blockchain. The list of transactions is in the same order as the order of the transactions in the proposed blockchain block. ‘read_set( )’ is a function that takes as input a transaction and returns the list of variables, ‘world_state’ and otherwise, read by the transaction. ‘RS’ represents the read set of the current node (transaction) being inserted into the lattice. ‘Top’ is the first node in the lattice (a directed graph) which has no predecessors. All paths through the lattice start with the Top and terminate with the Bottom. The Top is often represented by the symbol T (capital T)., transaction( ) is a function that returns the transaction associated with its argument, which is a lattice node. True or ‘T’ represent true in Boolean logic, ‘TxList’ is an ordered list of transactions extracted from a proposed block in the block chain. ‘write_set( )’ is a function that takes as input a transaction and returns the list of variables, world state and otherwise, written by the transaction. ‘WS’ represents the write set of the current node (transaction) being inserted into the lattice, ∪: is a symbol representing set union, ∩: is a symbol representing set intersection φ or Φ: are symbols that represent the empty set, ( ): parenthesis are used to disambiguate the meaning of mathematical expressions ‘=’ means assignment, for example, “test=7” is assigning the value of 7 to test. ‘==’ mean evaluation “test==5”, is asking whether the variable test has the value 5. The answer is either T (yes) or F (no) depending on the value of test. ‘N_WS’ represents the node write set acquired by write_set(transaction(LN)), ‘N_RS’ represents the node read set acquired by read_set(transaction(LN)), ‘∀’ is a mathematical symbol that means “for all”, ‘∈’ is a mathematical symbol that mean “element of”.

FIG. 6 illustrates a lattice creation algorithm flow diagram 600 according to another example embodiment. Referring to FIG. 6, the lattice creation algorithm builds the lattice based on an existing proposed transaction list, TxList, of transactions 602. The lattice structure Top node and Bottom node are initialized 604 and the list of proposed transactions is checked to determine if it is empty 606. If so the process is complete 608, if transactions remain in the list, the next transaction (NT) is removed from the list 610. Next an ordered list of nodes currently in the lattice is generated in breadth first order starting at Bottom and assigned to node_list 611. After that a new node (NN) is created including the NT, and attached to the Bottom 612. The write set WS is the write set of current transaction, NT, which is initialized 614. After that the read set, RS, of NT is initialized 616. The search for the correct location of NN in the lattice starts by initializing ‘found predecessor’ to false 618 and then LN is set to the next node from the breadth first ordered list of lattice nodes 622. The lattice is searched in a breadth first manner from the Bottom of the lattice for each new node to be inserted. If the WS and RS are checked to see if they are both empty 624. If so, the value of Found_pred is checked 664 to determine whether to insert the NN below the Top 662. If no prececessor is found, Found_pred==F, the the NN is inserted below top. If Bottom is in the list of descendants of Top, Bottom is removed from the list of descendants, 668. The algorithm continues by checking whether or not the transaction list, Txlist, is empty, 606. Returning to 624, if the read and write sets were not empty, we proceed to check whether LN is empty or equal to Top. If, the LN is an empty set or equal to the top of lattice, the same process that was used for read and write sets both empty occurs (664, 662, 668). If not, the write set is generated N_WS for the LN 632 along with a read set N_RS for the LN 634. If ((WS∩N_WS)∩(WS∩N_RS)∩(RS∩N_WS))≠636-642. Then if found_pred≠F 644, then a dependency edge is inserted between LN and created node NN 648. Otherwise, when found_pred==F (false), found_pred is set to T (True) 646, before creating the dependency link in 648. The expressions∀x∈((WS∩N_WS)∩(WS∩N_RS)) removes x from WS, ∀x ∈(RS∩N_WS) remove x from RS 652, removing from the read set and write set of the transaction being processed those variables that have been satisfied by the dependency edge just created. Next, if bottom is listed as a descendent of the node that was located, Bottom is removed from the list of descendants, 654. The algorithm continues by selecting the next node in the breadth first search that needs to be checked to see if it is a predecessor to NN.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

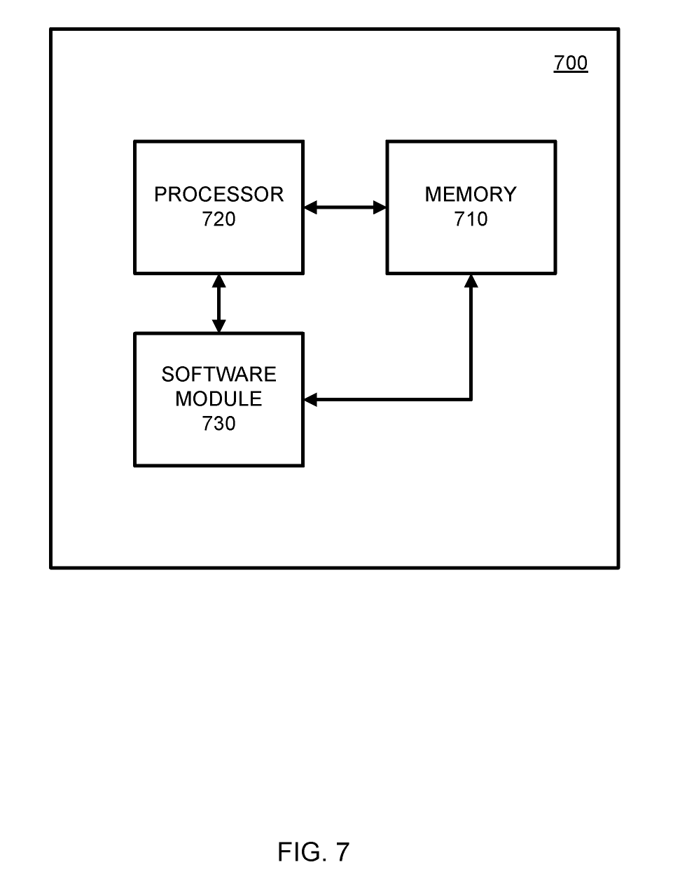

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 7 illustrates an example network element 700, which may represent or be integrated in any of the above-described components, etc.

As illustrated in FIG. 7, a memory 710 and a processor 720 may be discrete components of a network entity 700 that are used to execute an application or set of operations as described herein. The application may be coded in software in a computer language understood by the processor 720, and stored in a computer readable medium, such as, a memory 710. The computer readable medium may be a non-transitory computer readable medium that includes tangible hardware components, such as memory, that can store software. Furthermore, a software module 730 may be another discrete entity that is part of the network entity 700, and which contains software instructions that may be executed by the processor 720 to effectuate one or more of the functions described herein. In addition to the above noted components of the network entity 700, the network entity 700 may also have a transmitter and receiver pair configured to receive and transmit communication signals (not shown).

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving an ordered set of proposed transactions intended for inclusion in a blockchain block;
creating a lattice structure containing the proposed transactions for the blockchain block, the lattice structure comprising a top and a bottom and a plurality of nodes representing the proposed transactions;
determining an order of execution of the proposed transactions for the blockchain block via the lattice structure; and
processing the proposed transactions in the lattice structure in parallel based on a configuration of the lattice structure.

2. The method of claim 1, further comprising deter n , for each of the proposed transactions in the lattice structure, a write set in each of the proposed transactions and a read set of the proposed transactions.

3. The method of claim 1, further comprising during creating of the lattice structure, creating a new node of the lattice structure containing a next proposed transaction, with the new node connected above the bottom.

4. The method of claim 1, further comprising during creating of the lattice structure, inserting a new node containing a next proposed transaction, based on an order the next proposed transaction was received, retrieved from the proposed transactions for inclusion in the blockchain block, into the lattice below all nodes containing transactions having one or more of a write set containing any variable written by the next transaction, a write set containing any variable read by the next transaction, or a read set containing any variable written by the next transaction.

5. The method of claim 2, wherein the read sets and the write sets are determined by one or more of annotations of the proposed transactions, static analysis of transaction code associated with the proposed transactions, or dynamic analysis of the proposed transaction.

6. The method of claim 2, further comprising:
during creating of the lattice structure, creating a new node of the lattice structure, containing a next proposed transaction with the new node connected above the bottom; and
inserting the new node below the top of the lattice structure when the next transaction has no write set dependencies or read set dependencies on any other transaction currently in the lattice structure.

7. The method of claim 1, further comprising:
performing a breadth first search from the top of the lattice to schedule proposed transaction processing; and
scheduling execution of the proposed transactions associated with each of the plurality of nodes as the proposed transactions are identified in the breadth first search.

8. The method of claim 1, further comprising:
identifying one or more forks in the lattice structure as a point below which there are two or more of the plurality of nodes; and
scheduling execution of the proposed transactions associated with the two or more of the plurality of nodes in parallel based on available resources.

9. The method of claim 1, further comprising for each of the plurality of nodes comprising a proposed transaction to be scheduled, determining whether any of the plurality of nodes comprises a join, and for those that do comprise the join, suspending scheduling of proposed transaction execution associated with the nodes comprising the join until all the other of the proposed transactions associated with predecessor nodes in the lattice structure have completed execution.

10. The method of claim 8, wherein the scheduling of the proposed transactions completes when all of the plurality of nodes above the bottom have been scheduled.

11. The method of claim 1, wherein the processing of the proposed transactions completes when all scheduled proposed transactions have completed execution.

12. The method of claim 8, wherein the order of the execution of proposed transactions is based on one or more of information learned from prior executions, a set of computational resources expected to be consumed to execute the proposed transactions, or the quantity of the resources expected to be consumed to execute the proposed transactions.

13. The method of claim 1, further comprising:
selecting one or more of the plurality of nodes; and
when one or more of the plurality of nodes selected for scheduling contains multiple proposed transactions, scheduling the proposed transactions in the order they appear in the one or more of the plurality of nodes.

14. The method of claim 13, further comprising when the one or more of the plurality of nodes containing multiple proposed transactions is scheduled, considering the proposed transactions of the one or more of the plurality of nodes complete when a last of the proposed transactions of the multiple proposed transactions in the node has completed.

15. An apparatus, comprising:
a receiver configured to receive an ordered set of proposed transactions intended for inclusion in a blockchain block;
a processor configured to
create a lattice structure containing the proposed transactions for the blockchain block, the lattice structure comprising a top and a bottom and a plurality of nodes representing the proposed transactions,
determine an order of execution of the proposed transactions for the blockchain block via the lattice structure, and
process the proposed transactions in the lattice structure in parallel based on a configuration of the lattice structure.

16. The apparatus of claim 15, wherein the processor further configured to determine, for each of the proposed transactions in the lattice structure, a write set in each of the proposed transactions and a read set in each of the proposed transactions.

17. The apparatus of claim 15, wherein the processor is further configured to, during creation of the lattice structure, create a new node of the lattice structure containing a next proposed transaction, with the new node connected above the bottom.

18. A non-transitory computer readable storage medium configured to store instructions that when executed causes a processor to perform:
receiving an ordered set of proposed transactions intended for inclusion in a blockchain block;
creating a lattice structure containing the proposed transactions for the blockchain block, the lattice structure comprising a top and a bottom and a plurality of nodes representing the proposed transactions;
determining an order of execution of the proposed transactions for the blockchain block via the lattice structure; and
processing the proposed transactions in the lattice structure in parallel based on a configuration of the lattice structure.

19. The non-transitory computer readable storage medium of claim 18, wherein the processor is further configured to perform determining, for each of the proposed transactions in the lattice structure, a write set in each of the proposed transactions and a read set in each of the proposed transactions.

20. The non-transitory computer readable storage medium of claim 18, wherein the processor is further configured to perform during creating of the lattice structure, creating new node of the lattice structure containing a next proposed transaction, with the new node connected above the bottom.
